(19) United States
(12) Patent Application Publication
(10) Pub. No.: US 2025/0125675 A1
(43) Pub. Date: Apr. 17, 2025

(54) GENERATOR-MOTOR WITH MOVABLE MAGNETIC CORE AND STATIONARY MAGNETIC CORE

(71) Applicants: Omir Karimovitch BAYALIEV, KASKEIEN CITY (KZ); Almat SALGARIN, SUNNY ISLES, FL (US)

(72) Inventor: Omir Karimovitch BAYALIEV, Kaskeien city (KZ)

(21) Appl. No.: 18/966,248

(22) Filed: Dec. 3, 2024

Related U.S. Application Data
(63) Continuation-in-part of application No. 17/622,348, filed on Dec. 23, 2021, now abandoned.

(51) Int. Cl. H02K 1/2786; H02K 1/16

(52) U.S. Cl. CPC H02K 1/2786; H02K 1/16

(57) ABSTRACT

A generator-motor with a stationary magnetic core (stator) and a movable magnetic core (rotor) is provided. The stationary magnetic core is configured as a hollow cylinder having two annular bases. The movable magnetic core is configured as a cylindrical rod provided with a set of protrusions and configured to perform a reciprocating motion through the two annular bases of the hollow cylinder. A permanent ring magnet is arranged in the hollow cylinder around the movable magnetic core. A first generating winding extends along the outer surface of the magnet, while a second generating winding extends along the inner surface of the magnet around the movable magnetic core. Each of the first and second generating windings is in contact with both poles of the magnet such that there is an opposite transition of magnetic fluxes in the generating windings when the movable magnetic core performs the reciprocating motion.

### TECHNICAL FIELD

The present disclosure relates to the field of electromechanical energy conversion systems. In particular, the present disclosure relates to a generator-motor comprising a movable magnetic core acting as a rotor and a stationary magnetic core acting as a stator.

### BACKGROUND OF THE INVENTION

Linear and rotational generators-motors are well-known to be reversible machines that can operate in both generator and motor modes. Their operational principles are similar and schematically illustrated in FIGS. 1A and 1B.

Understanding of a linear generator-motor design can be obtained if one mentally cuts a stator 1 and a rotor 4 (with stator windings 2 and rotor windings 3) of a conventional asynchronous motor along a rotational axis (extending perpendicular to the plane of FIG. 1A) and unfold them into a flat plane as shown in FIG. 1B. The resulting “flat” design is a basic circuitry of the linear generator-motor. When the stator windings 2 of such a motor are connected to an alternating current (AC) main, a magnetic field will be produced, the axis of which will move along the air gap between the stator 1 and the rotor 4 with a speed V proportional to a frequency f of a supply voltage. Typically, the existing linear generators-motors have two types of mutual arrangement of their magnets and windings/coils.

FIG. 2A shows a generator-motor design comprising a stationary body 5 (also referred to as a yoke) having permanent magnets 6 fixed on its inner surface. A movable rod with fixed windings or coils 7 is placed inside the body 5. In particular, the rod is installed in the body 5 using sleeve bearings (not shown in FIG. 2A) and can perform a reciprocating motion from left to right, and vice versa. When the rod moves, an electromotive force (EMF) is induced in the windings 7 proportionally to a rate of displacement and a displacement amplitude ΔX. The displacement results in a magnetic flux ϕ transition by a value 40. Since the windings 7 will alternately (i.e., not simultaneously) enter the operating zones of the magnets 6 of different orientations, the function of the magnetic flux transition from the displacement amplitude in such a design will look as follows:

$$Δ ϕ = f ( Δ X ) .$$

An obvious disadvantage of this design is the need for sliding contacts (not shown in FIG. 2A) to conduct electricity from the windings 7 located on the moving rod.

FIG. 2B shows a similar generator-motor design, but with a reverse arrangement of the magnets 6 and the windings 7 inside the body 5. The function of the magnetic flux transition will be defined in a similar way as described above.

For a coil or winding in a variable magnetic field, the EMF can be defined, according to Faraday's law, as follows:

$$E = - Δϕ / Δ t ,$$

where E is the EMF acting along an arbitrarily chosen circuit, ϕ is the magnetic flux through the surface limited by this circuit, and t is the time of the magnetic flux transition.

Such alternate magnetic flux transition in the existing generator-motor designs means that the magnetic field in the windings 7 changes (increases or decreases) in one direction and then in the opposite. This leads to a slow transition in the magnetic flux inside the windings 7 and is the main disadvantage of such designs currently in use. A second disadvantage is the need for a big number of the magnets 6 and the windings 7, which leads to an increase in the cost of such designs. A third disadvantage is that not all the magnets 6 and the windings 7 work simultaneously during the entire reciprocating motion cycle. As clearly follows from FIGS. 2A and 2B, some of the magnets 6 (2 pieces on either side of the rod in FIG. 2A) or the windings 7 (2 pieces on either side of the rod in FIG. 2B) do not always interact with each other.

FIG. 3 illustrates portions of a self-starting synchronous motor disclosed in U.S. Pat. No. 3,999,107 A. The motor includes a stator body 14 having representatively three pole shoes 9, 10, and 11. The outer two pole shoes 9 and 11 respectively carry energizing coils 12 and 13. The central pole shoe 10 has a permanent magnet 8. The body of the stator 14 interconnects the pole shoes physically as well as magnetically. There is a horizontally movable element (rotor) 15 underneath the stator 14. The element 15 has individual, similar pole shoes identified by letters O, +a, −a, whereby arbitrarily the particular pole shoe of the element 15 which is aligned in FIG. 3 with the center pole 10 is denoted by character O and the other pole shoes are referenced thereto by the letter and sign notation. The motor also has magnetic shunt paths (iron) 16 and 17 running parallel to the permanent magnet 8 and having air gaps 18 and 19. The gaps may actually be filled with a non-magnetic material. These shunt paths compensate the usually low magnetic conductivity of permanent magnets and the much higher conductivities of these two shunt paths are beneficial for obtaining better conductance in the return paths for the flux as produced by the coils 12 and 13. Consequently, a current pulse of given amplitude-duration produces a higher magnetization with shunt than without shunt, so that for similar effects a lesser amplitude or shorter duration may suffice.

However, the motor design disclosed in U.S. Pat. No. 3,999,107 A still suffers, among others, from the same main disadvantage as the other existing motors, i.e., provides a slow transition in the magnetic flux inside the coils 12 and 13.

Given the above, more engineering is required to solve the above-mentioned issues of the existing generator-motor designs.

### SUMMARY OF THE INVENTION

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a generator-motor design that increases the generated EMF, minimizes the number of magnets and windings required for the generator-motor operation, and maximizes their utilization throughout a generation cycle.

The objective above is achieved by the features of the independent claim in the appended claims. Further embodiments and examples are apparent from the dependent claims, the detailed description, and the accompanying drawings.

According to an aspect, a generator-motor is provided, which comprises a stationary magnetic core acting as a stator, a movable magnetic core acting as a rotor, a permanent ring magnet, and two generating windings. The stationary magnetic core is configured as a hollow cylinder having two annular bases. The movable magnetic core is configured as a cylindrical rod provided with a set of protrusions and configured to perform a reciprocating motion through the two annular bases of the hollow cylinder. The permanent ring magnet is arranged in the hollow cylinder such that the permanent ring magnet surrounds the movable magnetic core. The first (outer or external) generating winding extends along an outer surface of the permanent ring magnet, while the second (inner or internal) generating winding extends along an inner surface of the permanent ring magnet and surrounds the movable magnetic core. Each of the first and second generating windings is in contact with both (north and south) poles of the permanent ring magnet such that there is an opposite transition of magnetic fluxes in the first generating winding and the second generating winding when the movable magnetic core performs the reciprocating motion. This leads to an increase in the generated EMF.

In one exemplary embodiment, the generator-motor may further comprise an excitation winding placed between the first generating winding and the outer surface of the permanent ring magnet. The excitation winding may be fed through a thyristor-controlled rectifier circuit.

In one exemplary embodiment, the hollow cylinder may have a radial annular cut.

Other features and advantages of the present disclosure will be apparent upon reading the following detailed description and reviewing the accompanying drawings.

### BRIEF DESCRIPTION OF DRAWINGS

The present disclosure is explained below with reference to the accompanying drawings in which:

FIGS. 1A and 1B show schematic views of a linear generator-motor in accordance with the prior art, namely: FIG. 1A shows the general view of the linear generator-motor; and FIG. 1B shows the “unfolded” view of the linear generator-motor which is obtained by mentally cutting the linear generator-motor along the rotor rotational axis and “straightening” the resulting cut;

FIGS. 2A and 2B schematically show two similar generator-motor designs in accordance with the prior art, each of which comprises a stationary body and a movable rod within the body, with permanent magnets and windings being attached to the body inner surface and the rod, respectively, and vice versa;

FIG. 3 shows portions of a self-starting synchronous motor in accordance with the prior art;

FIGS. 4A-4C schematically show a generator-motor according to a first exemplary embodiment, namely: FIG. 4A shows the generator-motor with a movable magnetic core (rotor) in an unshifted (neutral) position relative to a stationary magnetic core (stator); FIG. 4B shows the generator-motor with the movable magnetic core shifted to the left relative to the stationary magnetic core; and FIG. 4C shows the generator-motor with the movable magnetic core shifted to the right relative to the stationary magnetic core;

FIGS. 5A-5C schematically show transitions of magnetic fluxes in two windings connected in series in the generator-motor according to the first exemplary embodiment;

FIGS. 6A-6C schematically show a generator-motor according to a second exemplary embodiment, namely: FIG. 6A shows the generator-motor with a movable magnetic core (rotor) provided with prongs and being in an unshifted (neutral) position relative to a stationary magnetic core (stator); FIG. 6B shows the generator-motor with the movable magnetic core shifted to the right relative to the stationary magnetic core; and FIG. 6C shows the generator-motor with the movable magnetic core shifted to the left relative to the stationary magnetic core;

FIG. 7 schematically shows magnetic field lines in a ring magnet;

FIGS. 8A-8D schematically show a generator-motor according to a third exemplary embodiment, namely: FIG. 8A shows the generator-motor with a stationary magnetic core (stator) made in the form of a hollow cylinder having two annular bases and a radial annular cut, a permanent ring magnet placed in the hollow cylinder, and a movable magnetic core (rotor) made a cylindrical rod and shifted to the left relative to the stationary magnetic core through the two annular bases; FIG. 8B shows the same view as the one in FIG. 8A but with no radial cut in the hollow cylinder-instead, the uniformity of magnetic field lines is achieved by changing the thickness of the cylinder wall; and FIGS. 8C, 8D show how the density of magnetic flux lines changes when the movable magnetic core is displaced to the left relative to the stationary magnetic core;

FIGS. 9A and 9B schematically explain how an excitation winding can be placed in the area where the permanent magnet is located, in case of the generator-motor according to the second exemplary embodiment (see FIG. 9A) and the generator-motor according to the third exemplary embodiment (see FIG. 9B);

FIG. 10 shows a thyristor-controlled rectifier circuit through which the excitation winding can be fed;

FIG. 11 schematically shows a generator-motor according to a fourth exemplary embodiment, in which an element having a residual magnetization (e.g., made of a hard magnetic carbon steel material) is used as a permanent magnet in a stationary magnetic core (stator);

FIGS. 12A and 12B schematically illustrate the use of a control unit for controlling an AC three-phase supply voltage (see FIG. 12A) and the diagram of the supply voltage itself (see FIG. 12B);

FIG. 13 schematically shows a generator-motor according to a fifth exemplary embodiment, in which at least two stationary magnetic cores (stators) are used together with a single movable magnetic core (rotor); and

FIGS. 14A-14C show schematic views of a generator-motor according to a sixth exemplary embodiment, which can be used, for example, in modern wind turbines, namely: FIG. 14A shows the isometric view of the generator-motor, FIG. 14B shows the sectional view of the generator-motor with a single stationary magnetic core (stator) and a single annular movable magnetic core (rotor); and FIG. 14C shows the sectional view of generator-motor with two stationary magnetic cores (stators) and the single annular movable magnetic core (rotor).

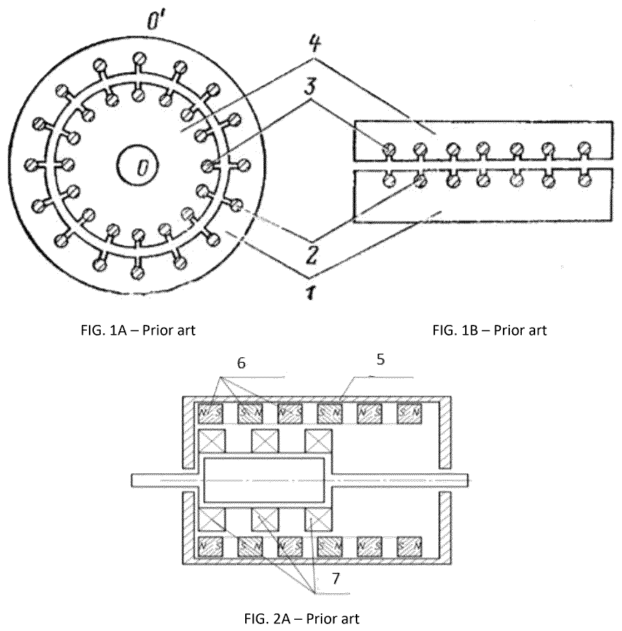

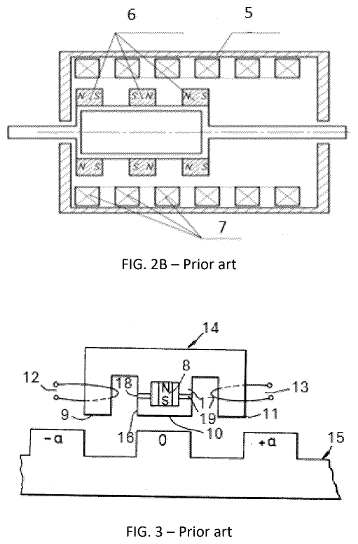

### DETAILED DESCRIPTION OF THE INVENTION

Various embodiments of the present disclosure are further described in more detail with reference to the accompanying drawings. However, the present disclosure may be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the device disclosed herein may be implemented in practice by using any numbers of the embodiments provided herein. Furthermore, it should be understood that any embodiment of the present disclosure may be implemented using one or more of the elements presented in the appended claims.

The word “exemplary” is used herein in the meaning of “used as an illustration”. Unless otherwise stated, any embodiment described herein as “exemplary” should not be construed as preferable or having an advantage over other embodiments.

Any positioning terminology, such as “left”, “right”, “top”, “bottom”, “above”, “below”, “over”, “under”, “upper”, “lower”, “horizontal”, “vertical”, etc., may be used herein for convenience to describe one element's or feature's relationship to one or more other elements or features in accordance with the figures. It should be apparent that the positioning terminology is intended to encompass different orientations of the apparatus disclosed herein, in addition to the orientation(s) depicted in the figures. As an example, if one imaginatively rotates the apparatus in the figures 90 degrees clockwise, elements or features described as “left” and “right” relative to other elements or features would then be oriented, respectively, “above” and “below” the other elements or features. Therefore, the positioning terminology used herein should not be construed as any limitation of the present disclosure.

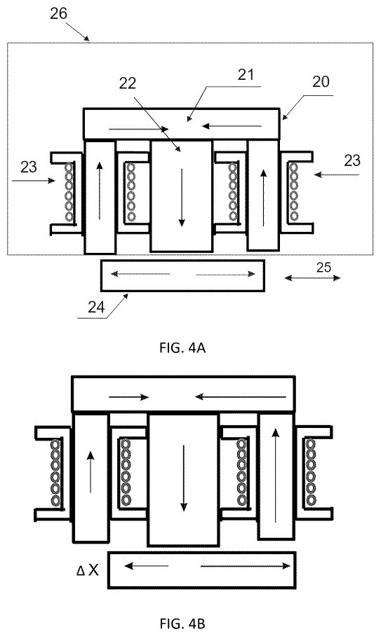

FIGS. 4A-4C schematically show a generator-motor according to a first exemplary embodiment. As shown, the generator-motor comprises a base element 26 that includes a C-shaped fixed or stationary magnetic core 20 and a permanent magnet 22 mounted at a midpoint 21 of the stationary magnetic core 20. There are two (left and right) generating windings 23 at the edges of the stationary magnetic core 20. A movable magnetic core 24 is configured to perform a reciprocating motion (i.e., a horizontal motion, as schematically designated by a double-headed arrow 25 in FIG. 4A). As an example, the movable magnetic core 24 may be mounted on ball-bearings (not shown in FIGS. 4A-4C). The direction of a magnetic flux through the generating windings 23 is shown by single-headed arrows. In this design, the stationary magnetic core 20 acts as a stator, while the movable magnetic core 24 acts as a rotor.

As shown in FIG. 4A, when the center of the movable magnetic core 24 is positioned against the midpoint 21, the magnetic field lines passing through the midpoint 21 (where the permanent magnet 22 is installed) are evenly distributed along the generating windings 23 and are counter-directional and equal in magnitude.

As shown in FIGS. 4B and 4C, when the movable magnetic core 24 shifts to the left or right by ΔX relative to the stationary magnetic core 20, this results in a variation of a magnetic resistance magnitude in the gaps between the generating windings 23 and the movable magnetic core 24. This variation in turn leads to an opposite deviation in the magnitudes of magnetic fluxes in the right and left generating windings 23 by the value of:

$$Δ ϕ = f ( Δ X ) .$$

The generating windings 23 are connected in series to form a single generating winding. The total transition of the magnetic flux in such a single winding is defined as follows:

$$Δ ϕ = f ( Δ X ) - ( - f ( Δ X ) ) = 2 f ( Δ X ) ,$$

That is, it increases by a factor of 2 compared to the one provided by typical generator-motor designs.

Unlike the typical generator-motor designs, the movable magnetic core 24 does not generate any magnetic field but is a passive element like a ferromagnetic core in a solenoid. It switches the magnetic lines through the permanent magnet 22 and the generating windings 23, thereby reducing the magnetic resistance between the permanent magnet 22 and the right generating winding 23 or the permanent magnet 22 and the left generating winding 23 (depending on whether the movable magnetic core 24 shifts to the right or to the left).

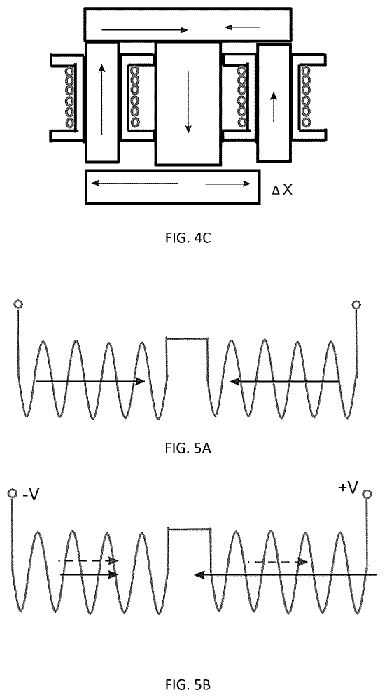

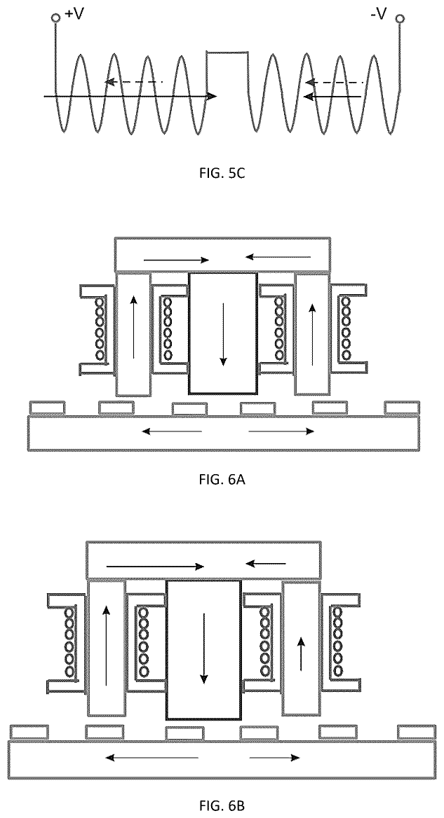

FIGS. 5A-5C schematically show the transitions of the magnetic fluxes in the generating windings 23 connected in series in the generator-motor according to the first exemplary embodiment. More, specifically, FIG. 5A corresponds to the case shown in FIG. 4A (i.e., when the movable magnetic core 24 is in an unshifted (neutral) position), FIG. 5B corresponds to the case shown in FIG. 4B (i.e., when the movable magnetic core 24 has moved to the right), FIG. 5C corresponds to the case shown in FIG. 4C (i.e., when the movable magnetic core 24 has moved to the left). In FIGS. 5B and 5C, the dotted arrows show the direction of the magnetic field induced by the resulting EMF, which is always directed against the transition of the magnetic flux.

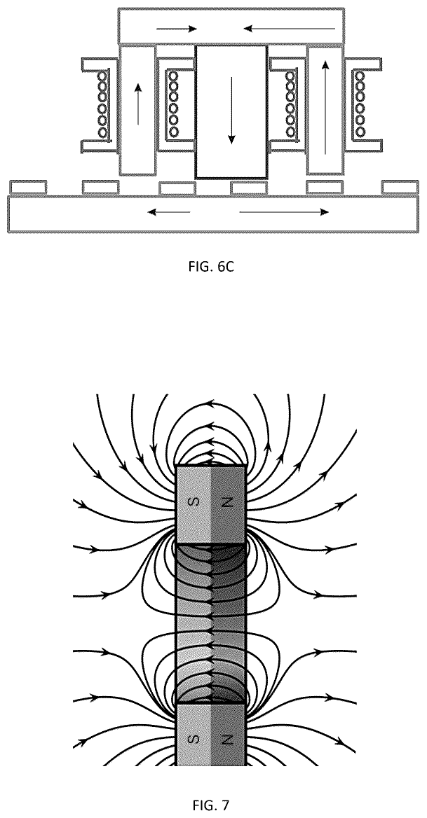

FIGS. 6A-6C schematically show a generator-motor according to a second exemplary embodiment. In general, the generator-motor according to the second exemplary embodiment has a similar design the generator-motor according to the first exemplary embodiment, with one exception: the movable magnetic core is provided with protrusions (prongs) on its side facing the stationary magnetic core. These protrusions provide the transitions of the magnetic fluxes at any (larger) displacement values ΔX. FIG. 6A shows the generator-motor with the movable magnetic core in an unshifted (neutral) position relative to the stationary magnetic core. FIG. 6B shows the generator-motor with the movable magnetic core shifted to the right relative to the stationary magnetic core such that the left edge of the stationary magnetic core faces (and is aligned with) one of the protrusions of the movable magnetic core, while the right edge of the stationary magnetic core faces (and is aligned with) the gap between the protrusions of the movable magnetic core. FIG. 6C shows the reverse case: the generator-motor with the movable magnetic core shifted to the left relative to the stationary magnetic core such that the right edge of the stationary magnetic core faces (and is aligned with) one of the protrusions of the movable magnetic core, while the left edge of the stationary magnetic core faces (and is aligned with) the gap between the protrusions of the movable magnetic core.

FIG. 7 schematically shows magnetic field lines in a ring magnet. Such a ring magnet may be used in the exemplary embodiments of the generator-motor, as will be described below in detail.

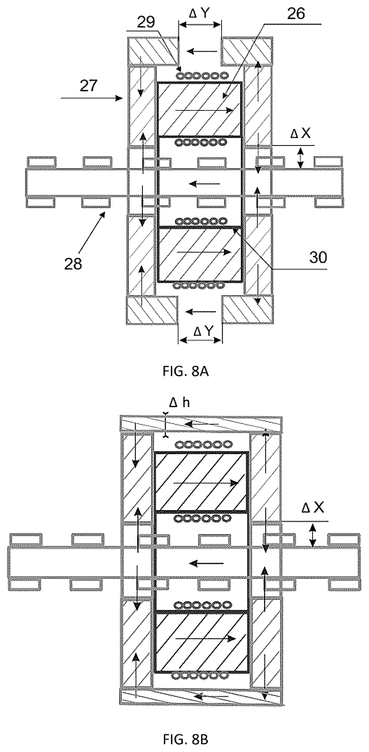

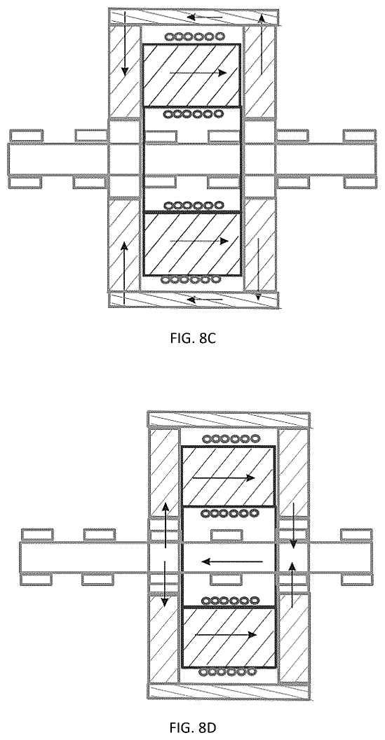

FIGS. 8A-8D schematically show a generator-motor according to a third exemplary embodiment.

As shown in FIG. 8A, a permanent ring magnet 26 (like the one shown in FIG. 7) is placed in the middle of a stationary magnetic core (rotor) 27 which is made in the form of a hollow cylinder having two annular bases and a technological cut AY. A movable magnetic core (rotor) 28 (e.g., in the form of a cylindrical rod) is configured move through the stationary magnetic core 27 along its rotation axis. The movable magnetic core 28 has protrusions on its external surface. An outer winding 29 and an inner winding 30 are used as two generating windings. The outer winding 29 extends along the outer surface of the permanent ring magnet 26, while the inner winding 30 extends along the inner surface of the permanent ring magnet 26 around the movable magnetic core 28.

The operational principle of the generator-motor according to the third exemplary embodiment is similar to that of the generator-motor according to the second exemplary embodiment. That is, the displacement of the movable magnetic core 28 changes the value of the magnetic gaps ΔX and, consequently, the density of the magnetic field lines outside and inside of the permanent ring magnet 26. As a result, some magnetic field lines pass from the outer side of the permanent ring magnet 26 into the inner side and back again.

The technological (annular) cut AY is used to adjust the uniformity of the magnetic field lines outside and inside of the permanent ring magnet 26 and is set by a manufacturer. A smaller technological cut redistributes the magnetic field lines inside the permanent ring magnet 26, while a larger technological cut redistributes the magnetic field lines outside the permanent ring magnet 26. It is also possible to adjust the uniformity of the magnetic field lines by changing a thickness Δh of the cylinder wall of the stationary magnetic core 27 during the manufacturing process, thereby changing its magnetoconductivity (see FIG. 8B). As the wall thickness Δh increases, the magnetic field lines are redistributed outside the permanent ring magnet 26, while a decrease of Δh causes them to be redistributed inside the permanent ring magnet 26. The outer and inner windings 29 and 30 are connected in series.

FIGS. 8C, 8D show how the density of magnetic flux lines changes when the movable magnetic core 28 is displaced further to the left relative to the stationary magnetic core 27.

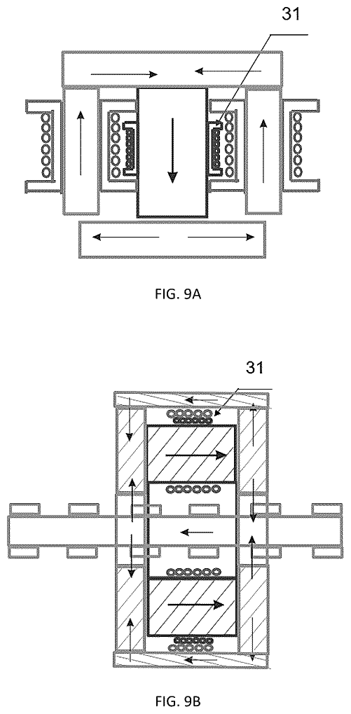

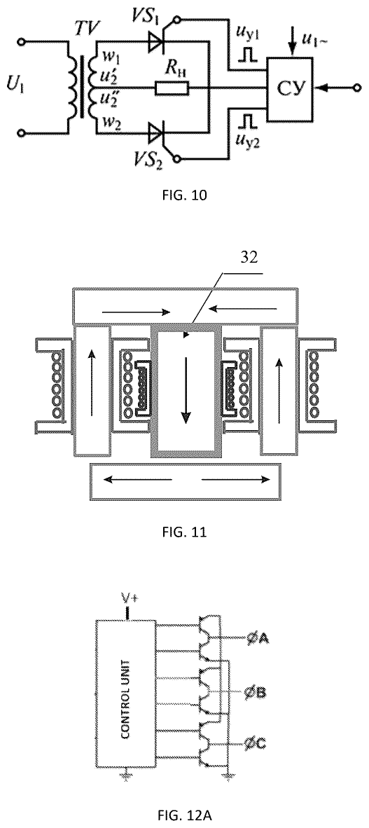

FIGS. 9A and 9B schematically explain how an excitation winding 31 can be placed in the area where the permanent magnet 22 or 26 is located, in case of the generator-motor according to the second exemplary embodiment (see FIG. 9A) and the generator-motor according to the third exemplary embodiment (see FIG. 9B). The excitation winding 31 may be used to increase the excitation of the magnetic field. The excitation winding may be fed from a common generating winding (not shown in FIGS. 9A and 9B) through a rectifier. For example, this could be implemented through a thyristor-controlled rectifier having a typical diagram shown in FIG. 10.

As follows from FIGS. 9A and 9B, each of the two generating windings (i.e., left and right in FIG. 9A corresponding to the generator-motor according to the second exemplary embodiment, and outer and inner in FIG. 9B corresponding to the generator-motor according to the third exemplary embodiment) is in contact with different poles of the permanent magnet. This provides an opposite transition of magnetic fluxes in these two generating windings when the movable magnetic core 24 or 28 performs a reciprocating motion relative to or through the permanent magnet 22 or 26, respectively.

FIG. 11 schematically shows a generator-motor according to a fourth exemplary embodiment. In general, the generator-motor according to the fourth exemplary embodiment has a similar design as the generator-motor according to the second exemplary embodiment, with one main exception: the permanent magnet is replaced with an element 32 having a residual magnetization (e.g., made of a hard magnetic carbon steel material) in the stationary magnetic core. Such an element may be exposed to a magnetic field produced by a magnetizing winding (not shown in FIG. 11), whereupon it can retain some residual magnetization and be used instead of the permanent magnet. This approach allows generating electricity at the initial stage of movement with further amplification of the magnetic field excitation due to the magnetizing winding. Also, an excitation winding (like the one shown in FIG. 9A) may be added to this generator-motor design.

The generator-motor according to the fourth exemplary embodiment may be controlled by the same thyristor-controlled rectifier circuit as the one shown in FIG. 10. A control system (CS) unit can be used to change the control angle and time of switching on of each thyristor, and hence an average rectified voltage and current.

The generator-motor according to any of the above-described exemplary embodiments is a reversible machine and can operate in a motor mode as similar machines. In the motor mode, the AC supply voltage must be applied to the generating windings (and the magnetizing winding, if any) through a generator with a control unit, as shown in FIG. 12A. The diagrams of the three-phase AC supply voltage are shown in FIG. 12B. The alternating magnetic field creates an EMF that drives the movable magnetic core. The direction of displacement will depend on the shift between the phases of the applied AC supply voltage. The speed of displacement depends on the frequency of the AC supply voltage.

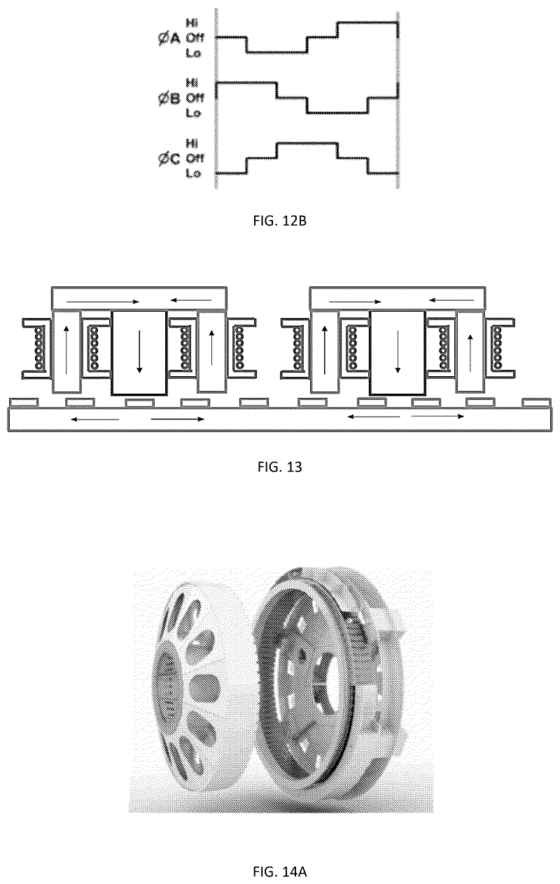

FIG. 13 schematically shows a generator-motor according to a fifth exemplary embodiment. In general, the generator-motor according to the fifth exemplary embodiment has a similar design as the generator-motor according to the second exemplary embodiment, with one main exception: two (or more) stationary magnetic cores (stators) are used together with a single movable magnetic core (rotor). This design allows one to increase the power produced in both the generator and the motor modes. It should be noted that the stationary magnetic cores (and the permanent magnets attached thereto) can be placed either on one or both sides of the movable magnetic core (in the latter case, the movable magnetic core may be provided with additional prongs on its backside).

The movable magnetic core may alternatively perform a rotational motion relative to the stationary magnetic core, as will be described below in detail.

In a traditionally used two-pole three-phase synchronous generator, the frequency f of current is expressed by the following relation:

$$f = N / 60 ,$$

where N is the number of rotor revolutions per minute (rpm).

For generators with p pole pairs, the frequency of current at N/60 rpm will be p times greater than for the two-pole generator, namely:

$$f = pN / 60.$$

Hence, the formula for determining the rotor rotation rate will be as follows:

$$N = 60 f / p .$$

To reduce the rotation rate of the generator, at a constant current frequency f, for example in wind turbines, it is necessary to use multi-pole designs, which increases their cost as it is necessary to use from 15 to 90 pairs of poles.

In such designs, as well as in traditional linear generators, the windings will alternately (i.e., not simultaneously) enter the operating zones of permanent magnets of different polarization and the function of the magnetic flux transition ϕ vs the magnitude of displacement will look as follows:

$$Δ ϕ = f ( Δ β ) ,$$

where β is the rotor rotation angle.

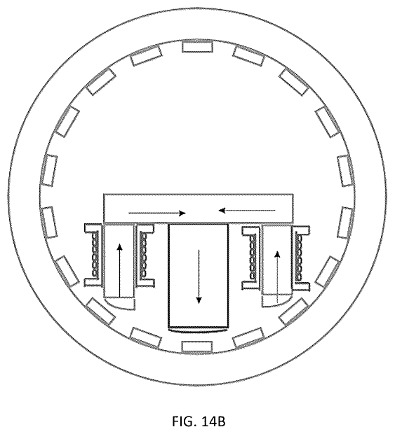

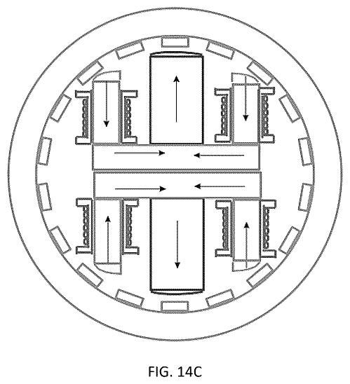

FIGS. 14A-14C show schematic views of a generator-motor according to a sixth exemplary embodiment, which can be used, for example, in modern wind turbines. More specifically, FIG. 14A shows the isometric view of the generator-motor, FIG. 14B shows the sectional view of the generator-motor with a single stationary magnetic core (stator) (e.g., like the one used in the generator-motor according to the first exemplary embodiment) and a single annular movable magnetic core (rotor); and FIG. 14C shows the sectional view of generator-motor with two stationary magnetic cores (stators) and the single annular movable magnetic core (rotor). The annular rotor has independent excitation windings that form the magnetic poles, and the stator winding (right in FIG. 14A) is located on the stator.

As shown in FIG. 14B, the generator-motor comprises two generating windings and one magnet arranged therebetween. It differs from the generator-motor according to the second exemplary embodiment (see FIGS. 6A-6C) only in that the movable magnetic core is made in a form of a ring and can rotate around the stationary magnetic core on bearings (not shown in FIG. 14B). At the same time, the operational principle of the generator-motor according to the sixth exemplary embodiment is similar to the one discussed above with respect to the previous generators-motors with the reciprocating motion of the movable magnetic core, except for the displacement trajectory of the movable magnetic core. The function of the magnetic flux transition ϕ from the angle of rotation will be as follows:

$$Δ ϕ = 2 f ( Δ β ) .$$

The rate of the magnetic flux transition will be twice of the currently available analogues.

To increase the power and achieve a more uniform distribution of the load, it is also possible to use two or more base elements with the same single movable magnetic core, as shown in FIG. 14C. The number of voltage phases will depend on the number of base elements (i.e., the stationary magnetic cores with permanent magnets). The base elements can also be located either inside or outside of the movable magnetic core with a proper arrangement of the prongs.

The output frequency will depend on the number of the protrusions (prongs) on the moving element as follows:

$$f = N * N p r ong / 60 ,$$

where N is the number of rotor revolutions per minute, and Nprong is the number of the prongs on the rotor (or the movable magnetic core).

The above formula shows that to increase the output frequency of the generator-motor it is enough to increase the number of the prongs in the movable magnetic core, and, therefore, the rotor speed can be reduced by the same amount that is very important for low-speed generators used at the wind and hydropower plants. In particular, the rotational speed of the shaft of the generator-motor shown in FIG. 14C at an output frequency of 50 Hz will be equal to:

$$N = 60 f / Nprong = 60 * 50 / 20 = 3 \; 000 / 20 = 150 rpm$$

The generator-motor with the rotational motion of the movable magnetic core is a reversible machine and can operate in the motor mode too. Using three base elements, a three-phase synchronous motor can be implemented with a typical set of rotation controls.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures may not be used to advantage.

1. A generator-motor comprising:
a stationary magnetic core acting as a stator, the stationary magnetic core being configured as a hollow cylinder having two annular bases;
a movable magnetic core acting as a rotor, the movable magnetic core being configured as a cylindrical rod provided with a set of protrusions, the movable magnetic core being configured to perform a reciprocating motion through the two annular bases of the hollow cylinder;
a permanent ring magnet arranged in the hollow cylinder around the movable magnetic core;
a first generating winding extending along an outer surface of the permanent ring magnet; and
a second generating winding extending along an inner surface of the permanent ring magnet around the movable magnetic core, the second generating winding and the first generating winding being connected in series;
wherein each of the first generating winding and the second generating winding is in contact with both poles of the permanent ring magnet such that there is an opposite transition of magnetic fluxes in the first generating winding and the second generating winding when the movable magnetic core performs the reciprocating motion.

2. The generator-motor of claim 1, further comprising an excitation winding placed between the first generating winding and the outer surface of the permanent ring magnet, and wherein the excitation winding is fed through a thyristor-controlled rectifier circuit.

3. The generator-motor of claim 1, wherein the hollow cylinder has a radial annular cut.
